(19) United States
(12) Patent Application Publication
(10) Pub. No.: US 2010/0080868 A1
(43) Pub. Date: Apr. 1, 2010

(54) Mash Process Offering Better Control

(75) Inventors: Thomas George Crosby, Frisco, TX (US); Pravin Maganlal Desai, Carrollton, TX (US); Ponnattu Kurian Joseph, Irving, TX (US); Renu Matthew, Plano, TX (US); Michael Grant Topor, Little Elm, TX (US); Gerald James Vogel, Plano, TX (US); Gregory Thomas West, Little Elm, TX (US)

Correspondence Address: CARSTENS & CAHOON, LLP, P O BOX 802334, DALLAS, TX, 75380, US

(73) Assignee: FRITO-LAY NORTH AMERICA, INC., Plano, TX (US)

(21) Appl. No.: 12/238,789

(22) Filed: Sep. 26, 2008

(51) Int. Cl. A23P 1/12; A23L 1/216

(52) U.S. Cl. 426/52; 426/473; 426/637

(57) ABSTRACT

A method for producing a dehydrated potato product and products incorporating the dehydrated potato product. The method includes macerating uncooked whole potatoes to form a slurry. The resultant slurry is then optionally decanted to remove excess liquid. Then the slurry is cooked to form a potato mash. The potato mash is then chilled which provides an opportunity to retrograde the starch as well as reduce the mash cohesiveness. The mash is then dehydrated to form a dehydrated potato product. Throughout various stages of processing, additives can be incorporated to adjust the texture, adhesiveness, taste, color, and shape retention of the final food product. The additives may be incorporated during the slurry phase wherein they are more readily absorbed. Further, additives may also be incorporated which reduce undesirable puffing.

### BACKGROUND OF THE INVENTION

1. Technical Field

The present invention relates to a method for producing dehydrated potato products. More specifically it relates to a processing method which offers increased control over the final attributes of the final product.

2. Description of Related Art

In the food industry, potato-based products are typically made from dough mixes incorporating potato derivatives such as potato flakes, potato flour, potato granules, and potato starch. Examples of such potato-based products include potato chips and potato sticks. The taste of the final product as well as other organoleptic properties are dependent on the properties of the dehydrated ingredients.

Typically, the dehydrated ingredients are prepared by cooking, mashing, and then drying. The potatoes are generally sliced into slices of about 0.5 inches and then cooked to achieve a pre-determined degree of gelatinization. The potato slices are typically cooked by either submersion in water or steam. The potato slices are cooked from about 200° F. to about 250° F. The potatoes are then comminuted to produce a potato mash. Typical means for comminuting potato slices include ricing, mashing, and shredding. After the mash is formed, it is then dried to form a dehydrated ingredient. The mash is typically dried to a moisture content of about 10%. However, the dehydrated potato products produced by such methods limit the functionality desired in the final food product. For example, current processes tend to produce dehydrated potato products which are highly gelatinized with limited degree of retrogradation. Consequently, when these dehydrated potato products are used to produce the final food product, the final product may not achieve a desired texture or flavor.

To help such products achieve desired qualities, additives are sometimes incorporated at various points in the process to enhance flavor, texture, and stability. However, the use of additives can only take a product so far. As an example, many reactions typically take place within the potato before the addition of additives. Many additives try to limit or reverse the effect of these reactions, but the effectiveness of such additives is limited. As a result, there can be a variance between the desired and actual attributes. Often it is desirable that a final product comprise an attribute which is unattainable using current processing techniques for the ingredients. For example, many consumers find it desirable to have a chip shaped to enhance dipping. Such chips must retain their desired shape. It has proven difficult, with current processing for dehydrated potato products, to produce a product which can maintain its desired shape. As stated above, while additives and emulsifiers can alleviate the problem to a degree, there is still a limit on the adjustments which can be made.

Another problem encountered in the production of potato products from dehydrated potato products is striping. Often using a mixture of dehydrated potato products results in a final product which has undesirable colored stripes. This is believed to be related to the amount of granules in the final product. However, with traditional dehydrated potato products, the use of granules was typically necessary to help a product retain its shape. Thus, using traditional dehydrated potato products, a user was forced to compromise between positives such as shape retaining qualities and negatives such as striping. It can be appreciated that it is desirable to control the shape retaining characteristics or a product without compromising product quality.

Still another problem encountered in the production of potato products from dehydrated potato product is puffing. As used herein, puffing comprises the formation of pillows and blisters.

Puffing results in the production of potato products, chips for example, during frying. Generally the starch in the outer cell layers becomes dehydrated quicker than does the inner cell layers. Steam gets caught in these cell voids and expands the cells apart. This results in the formation of blisters or pillows. If the blisters rupture then there are holes in the final product. Additionally, puffing typically results in concentrated areas of excess fat or oil, and consequently increases the fat content of the total product. It can be appreciated that in many applications puffing is undesirable. There are several techniques known in the art to reduce puffing. As puffing is a function of moisture content, many attempts to reduce puffing concentrate on reducing the moisture content. In turn, this minimizes tile formation of steam pockets that cause puffing. Other attempts include poking small holes in the final dough formation while the dough is being sheeted. The holes produced during this process are commonly called dockering holes. These holes act to limit the size of the blister. Along those same lines, other applications disclose the addition of larger particulates into the dough. For example European Patent Application number 82103377 to Willard discloses the addition of rice, oats, and other larger particulate solids into the dough. The patent claims that the amount of blisters in the final product is inversely proportional to the amount of particulate solids added to the dough. The particulate is sized to be at least the same thickness of the dough so that an appreciable amount of the particulate can extend through the surface of the dough. The particulates then provide a means to limit the formation of blisters. While many of these methods may be successful, they are not applicable to all product formulation. For example, most of the methods described above are directed to the preparation of dough which is subsequently sheeted. However, many applications do not employ sheeting but employ other processing methods such as extrusion. Further, it is undesirable for some products to have large particulate solids such as rice extending through the dough surface.

Consequently, it is desirable to have a method for producing a dehydrated potato product which allows better control of the attributes of the final product. Further, it is desirable to develop a method which can control puffing in processes other than sheeting. Still further, it is desirable to have a method which produces a better quality dehydrated product as well as subsequent products which incorporate the dehydrated product. Finally, it is desirable to have a method which may be utilized in the formation of a dipping chip which allows attributes such as texture, shape retention, adhesiveness, striping, and puffing to be better controlled.

### SUMMARY OF THE INVENTION

A method for producing a dehydrated potato product is provided. The method discloses macerating raw peeled potatoes to form a slurry comprising broken potato cell wall fragments, native potato starch granules, and intercellular fluids. After a slurry is formed the slurry is optionally decanted to remove excess fluid. By removing more or less fluid, the amount of soluble and dispersible potato components are adjusted leading to changes in the final product taste and texture. After decanting, the slurry is cooked, typically at about 175° F. to form a mash. During the cooking, most and perhaps all of the native potato starch granules are gelatinized. Reactions of other potato components may also occur. After cooking, the mash is chilled. Chilling provides an opportunity to retrograde part of the gelatinized native potato starch. After chilling, the mash is dehydrated to produce a dehydrated product or the chilled mash is combined with other ingredients and the mixture is dehydrated into a final product. Thus, the texture and taste of the dehydrated mash and products incorporating the dehydrated mash can be varied by altering the size of the particles formed during the maceration, changing the amount of excess fluid removal, and varying the time and temperature o f the cooking and cooling steps.

Another benefit of producing a slurry before cooking is the improved effectiveness of additives added to the slurry or the mash. Because a slurry is formed before cooking, potato components are released from the intact potato cells, and addition of additives can be made at the most advantageous time to influence the potato components reacted during the cooking of the slurry.

Additionally, by producing a slurry before cooking, additives can be added before and during cooking to control the reactions of the potato components. Additives can be added at various times and temperatures within the cooking phase to control gelatinization and enzymatic reactions. Various additives are added at various processing stages to produce a product with desired attributes. For example, additives are disclosed which allow the adjustment of texture, taste, and shape retention of the final product.

Finally, a novel method of processing dehydrated potato product and a potato dough comprising the dehydrated potato product is disclosed which reduces puffing of products formed from the resultant dough. Hard stock or other additives are added either during the formation of the dehydrated potato product or during the formation of the dough which reduce or eliminate undesired puffing of the final food product. Thus, the current invention discloses a novel method which offers better control of the processing of the dehydrated product, and consequently yields a more desirable dehydrated potato product and a more desirable final potato product which incorporates the dehydrated potato product.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts a flow diagram of one embodiment of the current invention.

### DETAILED DESCRIPTION

Several embodiments of Applicants' invention will now be described with reference to the drawings. Unless otherwise indicated, all percentages are weight percentages.

### Dehydrated Potato Product Formation:

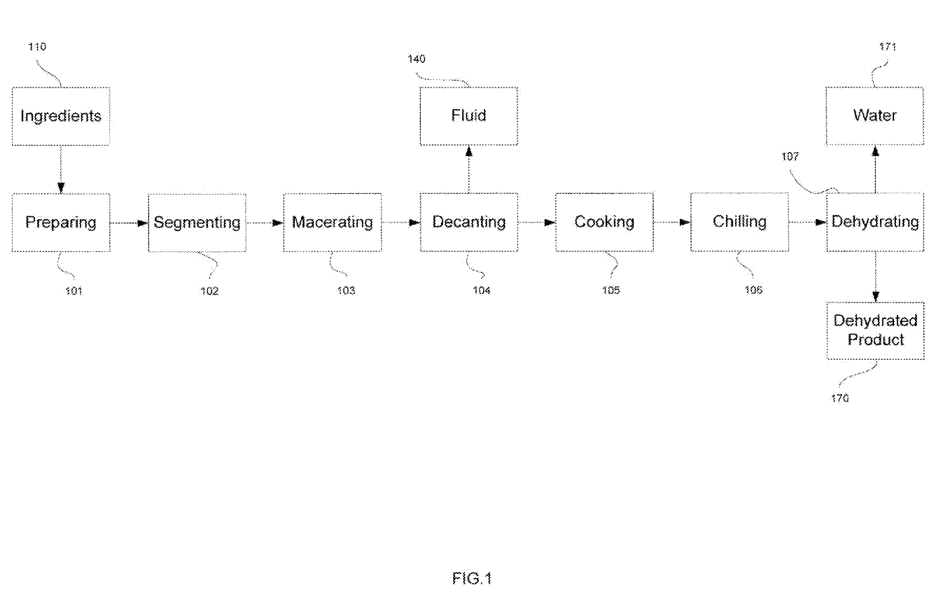

FIG. 1 is a flow diagram of one embodiment of the current invention. The flow diagram of FIG. 1 will be discussed as a batch operation. However, the method disclosed can successfully be performed with a semi-batch or continuous operation as well. The middle horizontal section of FIG. 1 refers to the seven processing steps and includes the preparing step 101, the segmenting step 102, the macerating step 103, the decanting step 104, the cooking step 105, the chilling step 106, and the dehydrating step 107. Thus, moving from left to right on the figure follows the processing of the food product from the first step of preparing 101 through the final dehydrating step 107. The addition of or removal of an ingredient within a step is shown with vertical arrows. Thus, as shown in the decanting step 104, fluid 140 is removed. Each of the processing steps and each of the ingredients will be discussed in detail below. It should again be noted that FIG. 1 shows only one embodiment of the current invention. Various steps and ingredients may be inserted or removed from the illustrated embodiment which are still within the scope of the current invention.

The first step in FIG. 1 is the preparing step 101. In this step the ingredients 110 are first obtained and optionally inspected for defects. In a preferred embodiment, the ingredients 110 comprise potatoes. In a more preferred embodiment, the ingredients comprise uncooked potatoes. The reason for having uncooked potatoes is that the enzymatic reactions which take place when a potato is cooked have not yet occurred. Additionally, some enzymes such as catalase and peroxidase are inactivated in cooking. Why these are desirable features will be explained in detail below. In a preferred embodiment the potatoes are at a temperature of about 60° F. to about 80° F., and more preferably at about 70° F. While an embodiment comprising potatoes is described, it should be noted that any type of comestible source may be substituted for potatoes such as, but not limited to, sweet potatoes, tubers, vegetables, and fruits. When referring to potatoes any commercially available potatoes may be employed including but not limited to Aurora, Bentgie, Idaho Russet, Kinnebec, Lady Rosetta, Mentor, Norchip, Norgold, Norkota, Sebago, Russet Burbank, Saturna, and Yukon Gold. Additionally, virtually any potato currently used for baking, snack production and French fry production may also be employed. Applicants' invention is ideally suited for the production of potato flakes, but the novel method may be successfully employed to produce other dehydrated potato products 170 including granules, flanules, and mixtures thereof. While Applicants' describe one embodiment with reference to potato flakes, it should be known that such references also include any dehydrated potato product 170. As used herein “dehydrated potato products” refers to any dehydrated potato product commonly produced including, but not limited to the products listed above. This is contrasted to the term “final product” which refers to a product incorporating the dehydrated potato product including but not limited to chips, sticks, and other food items.

In one embodiment, the preparing step 101 comprises treatment. Such treatment may include cleaning, peeling, cooling and blanching. These treatments are well known in the art and may be desirable in certain products. In potatoes, blanching is typically employed when it is desired to lower the level of reducing sugars that would cause a dark color during the final product dehydration if not removed. Further blanching acts to inactivate some enzymes which cause discoloration. Blanching or cooling may each be completed by immersing the potato in water. This provides for the blanching and cooling of the water and simultaneously washes dirt and other undesirable material from the potato. However, blanching and cooling is undesirable is some embodiments, and accordingly, in a preferred embodiment, the potatoes are not subjected to blanching.

Following the preparing step 101 is the segmenting step 102. The potatoes are segmented primarily for the ease in handling in the next step, macerating 103. Segmenting 102 can comprise slicing, dicing, ricing, cubing, etc. Virtually any method which reduces the size of the potatoes can be used in the segmenting step 102. It should be noted that the segmenting step 102 is optional. Potatoes are moved throughout the process with any means known in the art including conveying and pumping. In one embodiment of the segmenting step 102, potatoes are directed to a segmenter where they are sliced to a thickness of about ¼ of an inch to about one inch, more preferably from about ⅛ of an inch to about ½ of all inch. The segmenter used in the segmenting step 102 may comprise any cutting means known in the art which is capable of cutting potatoes into slices. The potatoes can be sliced either along the long diameter or the short diameter. If so desired, again depending on the desired attributes of the final product, a treatment solution is added to the sliced potatoes. As used herein, a “treatment solution” refers to a solution primarily used to control oxidation and discoloration. The treatment solution can be added to the potato during the preparing step 101, or after the segmenting step 102 including during or after the macerating step 103.

Following the segmenting step 102 is the macerating step 103. In the macerating step 103, the potatoes are macerated into potato particles to form a potato slurry. This is one difference between the current invention and the prior art. As discussed above, the prior art discloses cooking the peeled and segmented potatoes and then forming the mash. Applicants' have discovered several advantages to forming a slurry before cooking. These will be discussed in detail below. The slurry is formed using a micro-cutter or other known devices which are capable of macerating the potatoes and which allows the level of cell breakage to be controlled. A micro-cutter is a cutting device which is capable of macerating to a degree such that it produces product particle sizes on the order of about five-thousandths of an inch. One such device which is ideally suited for this invention is the Urschel Commitrol® by Urschel of Valparaiso, Ind. Further, depending on desired process simplicity, the potato may be macerated inside a pump such as the macerating elements available to a progressive cavity pump. As discussed above in the segmenting step 102, the potatoes may need to be reduced in size to allow proper handling in the macerating step 103. The size of the slurry particle s formed during the macerating step 103 is dependent on the starting material; typically, attempts are made to limit the size of the slurry particles to less than the size of the tissue cells of the starting material, depending on the desired final product attributes. In this way, the macerating step 103 will rupture most of the cell walls, if desired, releasing the cellular contents. Even with a small slurry particle size, a few cell walls may not be ruptured. In a preferred embodiment, the size of the slurry particles ranges from about 25% to about 200% of the cell size, with a preferred size of less than about 100% of the cell size. In one embodiment comprising potatoes, the particles are sized from about five thousandths of an inch to about several hundreds of an inch, and more preferably from about 0.005″ to about 0.01″. The macerating step 103 is carried out at temperatures ranging from about 60° F. to about 80° F. In a preferred embodiment, the macerating 103 takes place at about room temperature. The macerating step 103 is a vigorous step which results in a liquid slurry. The slurry formed by the macerating step 103 typically comprises a moisture content of about 76% to about 86%. It should be noted that no additional water has been added; all of the moisture present at this point has come from the potatoes. It should also be noted that in some embodiments, water will be added as a processing aid during various steps such as the segmenting step 102. Further water may be added for other reasons including the addition of additives or carry over from previous processing steps such as washing. The slurry formed, in one embodiment, has a viscosity from about 4 to about 12 Pa·s as measured at about 70° F. Unless otherwise discussed, all viscosity measurements were taken with a Capillary Rheometer. The Rheometer had a tube length of about 6.24 cm, an inner diameter of about 1.28 cm, and a piston diameter of about 3.55 cm.

In processes known in the art for producing dehydrated potato products 170, it has been found that most potato cells are broken upon mashing of cooked potato segments rather than during cooking of the potato segments. Lamberti et al. performed a series of experiments monitoring the effects of various processing techniques on a potato. Lamberti et al. found that after cooking, the cells appeared to remain intact, whereas after mashing the extracellular starch became visible. See Lamberti et al., Starch Transformation and Structure Development in Production and Reconstitution of Potato Flakes, Laboratory of Food Chemistry and Technology (2003). Some practitioners of the prior art believe that additional cells are broken during milling of dried potato flakes. Thus, the particle size distribution of potato flakes is an important attribute of flake functionality for users of potato flakes. When potato cells are broken they release their cellular contents into the slurry liquid. As soon as the cellular contents are released, they are subject to modification. The prior art discloses cooking and then mashing. Thus, because most cells remain intact during cooking, the potato components contained in the cells are not ripe for modification until after they are broken during the subsequent mashing step. This means the prior art method results in potato components contained in the intact cells which cannot be effectively modified during the cooking stage. Applicants', however, disclose forming a slurry before and/or during cooking. By so doing, Applicants' have increased the possibility for modification. By cooking after the slurry has been formed, and after the majority of the cellular contents have been released, these released contents may now be more effectively modified before or during cooking. Thus, the reactions and changes that previously took place unbridled may now be altered with the addition of additives. The possible additives and their consequences will be discussed in more detail below.

After the macerating step 103 is complete, an optional decanting step 104 begins. During the decanting step 104, excess fluid 140 is removed from the slurry. Whether a decanting step 104 is utilized and to what extent is dependent on the desired qualities of the final product. Additionally, decanting 104 may be utilized to obtain a consistent moisture level downstream as the natural moisture of the incoming potatoes can have great variability which may need correcting. As the fluid 140 removed during the decanting step 104 comprises some soluble flavor components, in some embodiments it may be desirable to skip the decanting step 104, leaving the excess moisture in the slurry unless separate steps are taken to recover these solids and flavors to be added back into the process. This is one reason why some embodiments do not utilize the decanting step 104. The decanting step 104 and the amount of moisture removed from the slurry during the decanting step 104 offer another control which is used to achieve the desired attributes such as taste and texture in both the dehydrated potato product 170 as well as subsequent final products which use the dehydrated potato product 170. Additionally, the decanting step 104 provides an opportunity to recover and recycle starch and flavor material removed from the separated fluid.

In embodiments wherein a decanting step 104 is utilized, the slurry is dewatered to a moisture content of between about 55% to about 75%, more preferably from about 60% to about 70%. The decanter, in one embodiment, is a standard mechanical fixed-wall decanter well known in the art. It should again be noted that as with other equipment described in the process, the decanter can either be designed for batch, semi-batch, or continuous operation. While the embodiment discussed comprises a decanter, it should be known that the current invention is not so limited, as virtually any other equipment which removes excess fluid, such as a centrifuge, may be utilized.

Decanting 104 offers several advantages besides acting as an additional control for adjusting the final product attributes. As will be described below, subsequent processing steps include cooking 105, chilling 106, and dehydrating 107. Each of these steps is typically energy intensive. For example, in the cooking step 105 the entire slurry is heated to a desired temperature. If the moisture content is reduced by about 10% by mass, for example, then there is about 10% less by mass that must be heated to the desired temperature. Thus, energy costs are reduced by reducing the mass to be heated. Likewise, the slurry is dehydrated to remove water 171 in a subsequent dehydration step 107. If a slurry comprises a lower moisture content when it is dehydrated, then less energy is required to dehydrate it to a desired moisture content. For example, it is known that if moisture is to be removed through thermal vaporization, the amount of heat required to vaporize the moisture is roughly five times the heat required to raise the temperature of the product to the boiling point. Thus, there is a large incentive to limit the amount of moisture that must be vaporized in order to conserve energy and reduce operating costs. Again, these energy saving benefits must be analyzed in light of any drawbacks associated with decanting such as the potential loss in flavor in the final product. Furthermore, while a 10% reduction in moistuLe content may at first glance appear minimal, it is actually quite considerable. For example, when a slurry having an initial moisture content of 80% is decanted to a moisture content of 70%, and is later dehydrated to a moisture content of 8%, then the decanting removed about 43% of the available moisture in terms of the solids. Thus, it can be appreciated that the decanting removes a considerable amount of moisture on a solids basis.

Returning to FIG. 1, after the decanting 104, or macerating 103 if the slurry is not decanted, the next step is the cooking step 105. During the cooking step 105, the slurry is cooked to form a mash. One purpose of the cooking step 105 is to reduce undesirable enzymatic reactions and to gelatinize the starch. It is desirable to gelatinize most of the available starch. However, in trying to gelatinize the majority of the starch, it is possible to overcook the slurry. Accordingly, in one embodiment the viscosity and the temperature of the slurry are measured while cooking 105. By measuring the viscosity and temperature of the slurry, the gelatinization of the mash can be predicted and controlled. By so doing, final product attributes which are dependent on gelatinization can be better controlled. In one embodiment the viscosity of the slurry is measured via an on-line viscometer. In one embodiment it is desirable that the viscosity of the cooked mash range from about 100 to about 450 Pa·s as measured at a temperature of about 167 to about 172° F. In another embodiment the degree of starch gelatinization can be monitored and thus controlled by monitoring cook time and temperature to achieve a desired RVA profile for the cooked mash.

The cooker employed in the cooking step 105 may comprise any container which may impart heat energy such as a heated kettle or other heat exchangers such as a scraped surface heat exchanger. In a preferred embodiment the slurry is heated to a temperature of about 130° to about 190° F., more preferably from about 170° to about 180° F. and most preferably about 175° F. The cooking 105 takes place at relatively low temperatures to maximize flavor retention while still reducing undesirable enzymatic activity. In a preferred embodiment, the cooking 105 takes place in a closed reactor with minimal or no headspace which further maximizes flavor retention. The cooking time varies with the moisture content and the heat exchangers employed and ranges from about 1 to about 45 minutes, more preferably from about 20 to about 30 minutes. In one embodiment the moisture content of the slurry entering the scraped surface heat exchange is about 70%, and the slurry is cooked for about 26 minutes. In some embodiments the cooking time and energy consumed during the cooking step 105 are reduced compared to the prior art. As discussed above, if the slurry has been previously decanted, then there is less mass which requires heating. Further, even if the slurry was not decanted, the potatoes in the slurry are in much smaller pieces than compared to the prior art half inch slabs. This smaller size produces increased surface area and reduced thickness resulting in increased heat transfer which in turn increases the efficiency of the heat exchanger and decreases the operating costs.

Returning again to FIG. 1, after cooking 105, the next step is a chilling step 106. During the chilling step 106, the mash is chilled. As used herein, “chilled” refers to the reduction of the temperature of a mass to an internal temperature below about 70° F. It is believed that native potato starch gelatinized during the cooking step 105 is partially retrograded during the chilling 106 step. Thus, the chilling step 106 changes the amount of gelatinized starch that is retrograded. As used herein, “retrograding” in respect to starch refers to the starch reverting back to its crystalline structure of native uncooked starch. Gelatinized starch which has been retrograded is generally less cohesive than gelatinized starch which has not been retrograded. It can be appreciated that the extent of retrogradation has a significant impact on both the dehydrated product 170 attributes as well as the attributes of the final products which incorporate the dehydrated product 170. Thus, chilling 106 offers an opportunity to adjust product attributes by controlling the extent of retrogradation.

As discussed above, because the cell contents are released into the continuous slurry before cooking 105, subsequent chilling 106 allows for the re-capture and modification of the starch lost in prior art methods during segmenting and the like which was washed away before cooking. Additionally, because the chilling step 106 results in increased retrogradation, the process allows for the production of a better dehydrated product 170. As discussed above, current processes tend to produce dehydrated products 170 such as potato flakes which are highly gelatinized and not sufficiently retrograded. Thus, the shape retention qualities of the finished product made from the potato flakes is limited. The combination of cooking 105 a raw slurry and the incorporated chilling step 106 offers further opportunity to control retrograding to achieve a desired product attribute, such as shape retention, even without the need for additives.

The equipment used in the chilling step 106 may comprise virtually any heat exchanger which can cool a material. For example, a chiller or a scraped surface heat exchanger may be successfully employed. In a preferred embodiment the mash is chilled to a temperature between about 50° to about 70° F., more preferably from about 60° to about 70° F., and most preferably about 68° F. The chilling time is dependent on moisture content and the equipment used to so chill the mash. In a preferred embodiment the mash is chilled from about 30 minutes to about an hour and a half, more preferably from about 45 minutes to about 75 minutes, and most preferably from about 50 minutes to about 65 minutes. In one embodiment, the chilled mash comprises a viscosity of between about 3,000 Pa·s to about 6,000 Pa·s measured at temperatures from about 65° F. to about 70° F.

As depicted in FIG. 1, after the chilling step 106 is the dehydrating step 107. The water 171 removed during the dehydrating step 107 or decanting step 104 may be used as an ingredient in dough formulations, recycled, or discarded. The amount and extent of dehydration is dependent on the product desired, but typically a moisture content of less than about 30% is desirable. In one embodiment, the mash is dehydrated to a moisture content of about 10%, preferably between about 8% to about 10%, depending largely on which type of dehydrated product 170 is desired. In one embodiment, the dehydrating step 107 comprises a dehydrator. Virtually any dehydrator which is capable of dehydrating a mash may be employed, such as a boiler or an oven. The temperature and pressure which are used in the dehydrator can be varied to achieve the desired attributes of the dehydrated product 170. In another embodiment, the mash is dehydrated under vacuum using a vacuum dryer or a vacuum drum dryer known in the art. In another preferred embodiment the mash is dehydrated in either a tray dryer or a drum dryer at mild conditions. In one embodiment, the surface temperature of the heated drum in a drum dryer ranges from about 310° F. to about 335° F., more preferably from about 300° F. to about 310° F. The pressure of the steam inside the drum of the drum dryer is about 150 pounds per square inch, more preferably from about 100 to about 110 pounds per square inch (absolute). After the dehydrating step 107 is complete, a dehydrated product 170 is formed. The product so formed can take the form of any dehydrated product 170 previously described including but not limited to potato flakes, potato flanules, potato granules, and potato flour, again all referred to by Applicants' as “potato flakes.” It should also be noted that a dried mash can be produced by this process which can match the functionality of a given dehydrated product 170 rather than matching the composition. For example, granules are cooked and dried single intact potato cells which provide almost no cohesion to a dough. Using applicants' process, the potato cells are typically broken, but by monitoring and controlling the cooking 105 and chilling steps 106 the amount of gelatinized starch as well as the amount of retrograded gelatinized starch in the dehydrated product 170 can be adjusted to mimic the functionality of potato granules, for example. Thus, the dehydrated product's 170 properties can be used to control properties such as cohesion in the dough or final products which incorporate the dehydrated potato product 170.

Once a dehydrated product 170, such as flakes, is produced, it is generally milled (not shown) to a desired particle size. The desired particle size is dependent on which dehydrated potato product 170 is produced. For example, if coarse potato flakes are produced, most of the weight of the flakes will be retained on a #40 sieve. If fine potato flakes are produced, most of the weight of the flakes will pass through a #40 sieve. The milling takes place in any equipment known in the art for producing milled product. The dehydrated product 170 thus formed is then ready to be combined with other ingredients to form final potato products.

### Dough and Chip Formation:

After milling, the dehydrated product 170 is typically combined with additional ingredients to form a potato dough which is then further processed to form a final product. As used herein “additional ingredients” refers to any other item which is mixed with the potato mash or the dehydrated potato product 170 to form a dough. Additional ingredients may include but are not limited to additives, water, other dehydrated potato products 170, modified starches, and potato pieces. Applicants' invention is ideally suited for the use of a variety of additives used in various processing stages. This aspect of the invention will be discussed in detail, under the heading “The Addition of Additives,” following a general description of the dough formulation.

The dough attributes as well as the final product attributes are obviously dependent on the type and amount of additional ingredients added to the potato mash or dehydrated product 170, depending when the addition occurs. It should be noted that the additional ingredients are added in virtually any processing step. For example, in one embodiment additional ingredients are added to the mash after chilling 106 and before dehydrating 107. In one embodiment, the dough comprises a viscosity between about 20,000 Pa·s to about 670,000 Pa·s as measured at a temperature of about 85° F.

Once a dough has been formulated, there are several steps which may be taken. For example, the dough may be formed into flat shaped pieces by sheeting the dough into a sheet and die cutting the sheet into pieces. Additionally, pieces of varying shapes can be formed by extruding the dough through a variety of dies. The pieces can then be baked, fried, or partially dried and then finish fried. In another embodiment, the dough is extruded under low shear rates, to form extrudate with a specified shape such as a scoop. The extrudate is subsequently fried at temperatures of about 300° F. to about 400° F. for a time of about 1 minute to about 8 minutes, more preferably from about 1.5 minutes to about 3.5 minutes. To reduce oil pick up during frying or enhance shape retention during frying, the extrudate can optionally be dehydrated to a moisture content of about 6% to about 30%, more preferably from about 6% to about 12%, before being fried. In one embodiment, the dough is extruded to form a chip shaped for dipping, which retains its preset shape after frying.

### The Addition of Additives:

One embodiment of a method of producing dehydrated potato products 170 has been described. The method results in an improved dehydrated potato product 170 and consequently, an improved final product which incorporates the improved dehydrated potato product 170. For example, one embodiment has been shown which discloses the ability to control both the retrograding and other attributes such as taste of both the dehydrated product 170 and the final products incorporating the dehydrated product 170 without the use of additives. This is a useful processing tool as many additives are very costly. The elimination or reduction of their use allows for decreased material and operating costs. Likewise, if a manufacturing design plan does not include a footprint for additives, this can offer significant capital savings. However, while in one embodiment additives are not added, in other embodiments additives are added at various processing stages. In one embodiment, additives are added after the dehydrating step 107, while in another embodiment the additives are added before the chilling step 106. It should be noted that the additives may be added at the same or different processing steps than other additional ingredients. For example, additives may be added during the chilling step 106, whereas other additional ingredients such as water and other dehydrated potato products 170 are added alter the dehydrating step 107. In another embodiment both the additives and other additional ingredients such as water and other dehydrated potato products 170 are simultaneously added after the dehydrating step 107. Because the invention produces a slurry before cooking 105, the invention is ideally suited for the addition of additives at virtually any point in the process. For example, by performing the macerating step 103, which produces fewer intact cells, the chemical composition can be modified before, during, or after cooking 105 and chilling 106. As the cooking step 105 involves a slurry comprising broken cells rather than whole or sliced potatoes with their cells intact, additives can be more readily absorbed by the slurry than compared to the prior art wherein the additives were not as able to penetrate the intact cell walls of the potato pieces. Additives can be added to the slurry at specific times or temperatures of the cooking step 105 which leads to different attributes in the dried product. For example, additives may be added during the cooking step 105 which suppress some enzymatic reactions and encourage others. This novel method increases both the effectiveness of a given additive as well as the possible additives which may successfully be used. Again, this was not possible with the prior art. An “additive”, as used herein refers to any compound, element, or solution which can modify potatoes. It should be noted that as used herein, an additive is separate from and does not include the treatment solution as described above. Thus, in one embodiment, potato segments may be treated with a treatment solution to control discoloration or oxidation and have additives added after the macerating step 103. Applicants' invention can utilize virtually any additive known in the art to modify potatoes. These additives include, but are not limited to, emulsifiers, monoglycerides, diglycerides, calcium chloride, pectin methyl esterase, amaylase, lecithin, citric acid, active yeast and other fermenting agents, etc. The additives can also include acrylamide reducing agents including but not limited to asparaginase, food grade acids, a pH reducing salt having a pKa of less than about 6, such as calcium chloride, amino acids including cysteine, lysine, glycine, histidine, alanine, methionine, glutamic acid, aspartic acid, praline, phenylalanine, valine, and arginine, as well as any acrylamide reducing agent disclosed in U.S. patent application Ser. No. 11/624,476. An acrylamide reducing agent is an agent which reduces the formation of acrylamide in foods. The additives may be added to adjust texture, taste, adhesiveness, viscosity, and shape retention of the dehydrated potato product 170 as well as the final food product which incorporates the dehydrated potato product 170. Again, these additives can be added to the wet slurry or at virtually any point in the process. Various embodiments discussing these additives are discussed in more detail below. These embodiments are described for illustrative purposes only and should not be deemed limiting.

In one embodiment, pectin methyl esterase (PME) is added to the slurry before cooking 105. Many tubers contain some of this enzyme naturally. However, as a tuber is heated between about 122° F. and about 158° F., a signficant amount of this enzyme, both naturally occurring and added, strengthens pectin methyl esters contained in cell wall components. Varying the time of heating at these temperatures or adding more PME during the slurry stage are two ways that allow adjustment of the stiffness of the resultant mash and subsequent final product shape retention. Thus, the shape retention qualities of the final product can be adjusted by introducing PME before cooking 105. This would have proven difficult or impossible in the prior art as the potato was first cooked and then mashed. Again, forming a slurry during the macerating step 103 which occurs before the cooking step 105 allows introduction of the enzyme into portions of the potato which was not possible with the prior art. Further, while generally described as being introduced before cooking 105, in other embodiments, it is desirable to introduce PME at other processing stages.

In another embodiment, amounts of monoglycerides or diglycerides (hereinafter “partial glycerides”), or mixtures thereof are added to the potato slurry, potato mash, or dough. In one embodiment the partial glycerides are added in an amount of about 0.1% to about 10% dry basis of the slurry, with a preferred range of about 1% to about 5% dry basis of the slury. Partial glycerides can be added at any time, but in a preferred embodiment the partial glycerides are added to the slurry before cooking 105. This prevents the gelatinized amylose from retrograding which is typically a fast reaction. As discussed above, the extent of retrogradation affects variables such as cohesiveness in the final product. Thus, partial glycerides are added as another means for controlling texture of the resultant final product.

Additionally, both enzymatic and fermentation reactions can take place during the cooking step 105 or chilling step 106. Thus, enzymes or fermentation agents can be added when the cooking temperature or chilling temperature is optimal for additive effectiveness. As used herein a “fermentation agent” includes agents, such as yeast, which convert carbohydrates into alcohols or acids under anaerobic conditions. The cooking slurry or chilling mash can be held at the optimum temperature and time until the additives yield the desired degree of reaction in the slurry or mash. Many of these enzymes react with soluble potato components including but not limited to reducing sugars, such as glucose or fructose, and free amino acids. As previously discussed, potato blanching or decanting 104 before cooking 105 can result in loss of flavor and browning compounds such as reducing sugars. If blanching or decanting 104 is not utilized, the potato slurry may actually contain too many reducing sugars to allow an acceptable color or flavor of the final product made with the dehydrated product 170. These additive reactions provide an additional way to control color and flavor of the final product made with the dehydrated product 170.

In another embodiment, additives and ingredients are adjusted to control puffing in subsequent final products. As discussed above, in one embodiment once a mash is produced, it is dehydrated and mixed with other ingredients to form dough. The dough is then extruded to form extrudate before being fried. If the extrudate is sufficiently dehydrated it can be difficult to achieve the desired finished product texture as the actual texture can be too hard. Further, a large percentage of the final product can exhibit puffing, which as described above, undesirably affects appearance, texture, and oil content of the final product. The problem is exaggerated if the extrudate is not sufficiently dehydrated as there is more steam available to produce blisters or pillows. However, it has been discovered that adding particulate fat or hard stock to the slurry, mash, or dough results in improved texture and reduced puffing. “Hard stock”, as used herein refers generally to triglycerides and other lipids which comprise a high melting point typically greater than about 135° F. It has further been discovered that adding particulate monoglyceride, diglyceride, or a mixture thereof, has a similar effect as does the particulate hard stock. In a preferred embodiment partial glycerides are added to comprise from about 0.5% to about 10% dry basis of the slurry. The use of such partial glycerides further allows Applicants' to simultaneously reduce puffing while also controlling the texture of the final product as described above. Thus, the use of partial glycerides is preferred in one embodiment as one additive produces two desired effects. However, other such particulates known in the art may also be successfully employed. For example, hard stock is preferable in one embodiment as it generally does not interact with the potato mash or dough. When used, hard stock is typically added to comprise from about 0.5% to about 10% dry basis of the slurry. While embodiments have been described as using either partial glycerides or hard stock, in other embodiments it may be desirable to use a combination of partial glycerides and hard stock. It can be appreciated that because particulate is added to reduce puffing, it is preferably added at a processing point such that it gets evenly distributed throughout the slurry, mash, or dough.

Applicants' discovery is different from the particulate additions of the prior art which added particulates to dough which was subsequently sheeted. Applicants' method allows for particulate additions and the accompanying reduction in puffing in processes other than sheeting, including for example, extrusion. However, while one goal of the instant invention is to control puffing in processes which utilize means other than sheeting, the instant invention can also be used in conjunction with sheeting. Thus, one novel feature of the instant invention is its flexibility in processing as it can be utilized in a variety of processes.

Regarding extrusion, even in low temperature and low pressure extrusion there is the risk of particle attrition and melting, which reduces the effectiveness of the particulate. This is contrasted to the prior art which discloses the addition of solid particulates to the dough before sheeting. These solid particulates, whether rice or hard stock, were not likely to melt during sheeting. As a result, little attention was paid to the melting point of the particulate. However, as the current invention allows the introduction of additives at any time, including before cooking 105 or dehydrating 107, extra care must be taken to ensure the selection of particulates which are not appreciably melted before the frying or baking. It follows that the selection of the particulate mandates at which stage in the process it is added. For example, monoglyceride has a melting point greater than about 150° F. Thus, monoglyceride may be added to the slurry stage so long as the cooking 105 and dehydrating steps 107 stay below the melting point of the monoglyceride or the exposure is sufficiently short to prevent complete melting. If, for example, the dehydrating step 107 takes place at about 300° F., then monoglyceride is preferably added after the dehydration step 107. The particulate is added anytime, depending on processing conditions, prior to extrusion. Ideally, the product is extruded with the particulate in its solid state. This means that particulate is chosen which has a melting point greater than the processing conditions for forming the mash. If the particulate is not appreciably melted until frying for example, then when the particulate melts it forms very small voids in the dough. The size of these voids is a function of the particle size and melting point of the particulate. It should be noted that some melting of the particulate can occur so long as the remaining particle is sufficiently large to leave a void as it melts in the finished product during the final cooking or frying step. Because the dough now has voids, the formation of pillows or blisters becomes more difficult. In many embodiments partial gylcerides are preferred over hard stock because hard stock, which comprises a lower melting point, melts more quickly during frying than partial glycerides all else being equal. As previously discussed the partial glycerides may also interact with the starch (amylose). It is generally preferred, as described above, that the particulate melts upon frying, resulting in the formation of voids and modification of texture. While typically partial glycerides are preferred over hard stock, both partial glycerides and hard stock, and mixtures thereof, may be added to effectively prevent puffing.

While the melting point of the particulates is one factor in the selection of the particulates to be employed, the particulate size is a second factor. As described above, the size of the resultant voids is dependent on the size of the particulate. In prior art applications, the particulate was generally smaller than the size of the nips associated with the sheeter. If the particulate was as large or larger than the nips, holes were formed which were visible in the product. In many final products these holes are undesirable, whereas in other final products these holes are desired since they have the same effect as dockering. Thus, in some final products, these holes may be desired in lieu of or in addition to mechanical dockering. If extrusion is employed, it is likewise generally preferable that the particulate size be smaller than the die of the extruder to avoid these often undesirable-visible holes in the final product. The size of the particulate can be adjusted to prevent the formation of visible holes in the final product, if the prevention of these holes is desired. Typically smaller sizes are employed to reduce the formation of holes. In one embodiment the size range of the preponderance oft particulate ranges from about 5% to about 130% of the dough thickness. In a more preferred embodiment, the size range of the preponderance of particulate ranges from about 25% to about 90% of the dough thickness. It can be appreciated that various processing conditions may result in attrition or melting of the particulate, reducing the size of the particulate. The change in size of the particulate can be accounted for and offset by introducing larger particulate with the knowledge that mean particulate size will be smaller upon extrusion or frying. Converse to that, one can use processing conditions to melt the particulate to such a degree as to achieve a desirable size. One skilled in the art can appreciate the benefit controlling the size distribution as well as the particulate shape to provide optimized product impact. It has been found that having a minority of very small particulates and a minority of very large particulates did not have a significant negative impact on the finished product. Taken further, having all the particles of one size or several specific sizes or even non-normal distributions may provide specific benefits for some products.

In summary, the invention discloses a method for producing dehydrated potato products 170 which allows increased control over the final attributes of the products 170 as well as products which incorporate the dehydrated potato products. While the invention has been particularly shown and described with reference to several preferred embodiments, it will be understood by those skilled in the art that various changes in form and detail may be made therein without departing from the spirit and scope of the invention.

What is claimed is:

1. A method for preparing a dehydrated potato product, said method comprising the steps of:
a) macerating raw potato stock into potato particles, thereby forming a potato slurry;
b) cooking said potato slurry thereby forming a potato mash;
c) chilling said potato mash; and
d) subsequently dehydrating said potato mash to form a dehydrated product.

2. The method of claim 1 wherein said method further comprises reducing the moisture content of said potato slurry after said macerating of step a).

3. The method of claim 2 wherein said moisture content of said potato slurry is reduced to about 55% to about 75%.

4. The method of claim 2 wherein said moisture content of said potato slurry is reduced to achieve desired flavor attributes in subsequent products.

5. The method of claim 2 wherein said moisture content of said potato slurry is reduced to achieve desired texture attributes in subsequent products.

6. The method of claim 2 wherein said reducing comprises reducing via a decanter.

7. The method of claim 1 further comprising the steps of:
e) extruding said product to form an extrudate;
f) frying said extrudate to form a scoop shaped chip.

8. The method of claim 1 further comprising the step of adding a treatment solution before said cooking of step b).

9. The method of claim 1 further comprising the step of adding a treatment solution after said cooking of step b).

10. The method of claim 1 further comprising the step of adding an additive before said cooking of step b).

11. The method of claim 1 further comprising the step of adding an additive during said cooking of step b).

12. The method of claim 1 further comprising the step of adding an additive after said cooking of step b).

13. The method of claim 1 further comprising the step of adding an additive after said dehydrating of step d).

14. The method of claim 1 further comprising the step of adding an additive comprising partial glycerides.

15. The method of claim 1 further comprising the step of adding an additive comprising pectin methyl esterase.

16. The method of claim 1 further comprising the step of adding an additive comprising an enzyme which reacts with soluble potato components.

17. The method of claim 1 further comprising the step of adding an additive comprising hard stock.

18. The method of claim 1 further comprising the step of adding an additive comprising a fermenting agent.

19. The method of claim 1 further comprising the step of adding an additive comprising an active live yeast.

20. The method of claim 1 further comprising the step of adding an additive comprising an acrylamide reducing agent.

21. The method of claim 1 wherein said macerating of step a) is performed using a micro-cutter.

22. The method of claim 1 wherein said macerating of step a) results in potato particles which are sized from about 0.005 of an inch to about 0.01 of an inch.

23. The method of claim 1 wherein said macerating of step a) results in potato particles which are sized from about 25% to about 200% of a potato cell.

24. The method of claim 1 wherein said cooking of step b) coimprises cooking at a temperature of about 130° F. to about 190° F.

25. The method of claim 1 wherein said cooking of step b) comprises cooking in a scraped surface heat exchanger.

26. The method of claim 1 wherein said cooking of step b) further comprises monitoring viscosity and temperature to reach a desired viscosity.

27. The method of claim 1 wherein said cooking of step b) further comprises controlling and monitoring cook time and temperature to achieve a desired RVA profile for the cooking mash.

28. The method of claim 1 wherein said chilling of step c) comprises chilling to a temperature of about 50° F. to about 70° F.

29. The method of claim 1 wherein said dehydrating of step d) comprises dehydrating to a moisture content of less than about 30%.

30. The method of claim 1 wherein said dehydrating of step d) comprises dehydrating to a moisture content of between about 6% and about 12%.

31. The potato product formed by the nmethod of claim 1.

32. A scoop shaped potato chip formed by the method of claim 31.

33. A potato chip formed by the process of:
a) macerating raw potato stock into potato particles, thereby forming a potato slurry;
b) cooking said potato slurry to a temperature of about 130° F. to about 190° F., thereby forming a potato mash;
c) chilling said potato mash to a temperature of about 50° F. to about 80° F.;
d) dehydrating to a moisture content less than about 30% to form a dehydrated product;
e) extruding said product thereby forming extrudate; and
f) frying said extrudate thereby forming a potato chip.

34. The process of claim 33 further comprising reducing the moisture content of said potato slurry after said macerating of step a) to about 55% to about 75%.

35. The process of claim 33 further comprising the step of adding a treatment solution before said cooking of step b).

36. The process of claim 33 further comprising the step of adding a treatment solution after said cooking of step b).

37. The process of claim 33 further comprising the step of adding an additive before said cooking of step b).

38. The process of claim 33 further comprising the step of adding an additive during said cooking of step b).

39. The process of claim 33 further comprising the step of adding an additive after said cooking of step b).

40. The process of claim 33 further comprising the step of adding an additive after said dehydrating of step d).

41. The process of claim 33 further comprising the step of adding an additive comprising partial glycerides.

42. The process of claim 33 further comprising the step of adding an additive comprising pectin methyl esterase.

43. The process of claim 33 further comprising the step of adding an additive comprising hard stock.

44. The process of claim 33 further comprising the step of adding an additive comprising an enzyme which reacts With soluble potato components.

45. The process of claim 33 further comprising the step of adding an additive comprising a fermenting agent.

46. The process of claim 33 further comprising the step of adding an additive comprising an active yeast

47. The process of claim 33 further comprising the step of adding an additive comprising all acrylamide reducing agent.

48. The process of claim 33 wherein said macerating of step a) is performed using a micro-cutter.

49. The process of claim 33 wherein said macerating of step a) results in potato particles which are sized from about 0.005 of an inch to about 0.01 of an inch.

50. The process of claim 33 wherein said macerating of step a) results in potato particles which are sized from about 25% to 200% of a potato cell.
